(19) United States
(12) Patent Application Publication
(10) Pub. No.: US 2024/0101793 A1
(43) Pub. Date: Mar. 28, 2024

(54) MOLDING MATERIAL

(71) Applicant: SEIKO EPSON CORPORATION, Tokyo (JP)

(72) Inventors: Tomohiro FUJITA, Matsumoto (JP); Shinobu YOKOKAWA, Okaya (JP); Chieko NAKAJIMA, Suwa (JP)

(21) Appl. No.: 18/473,337

(22) Filed: Sep. 25, 2023

(30) Foreign Application Priority Data
Sep. 27, 2022 (JP) 2022-153439

(51) Int. Cl. C08L 1/02

(52) U.S. Cl. CPC C08L 1/02; C08L 2205/03; C08L 2205/16

(57) ABSTRACT

A molding material includes a resin and cellulose fibers, in which the content of the cellulose fibers is 50% by mass or more based on the total mass of the molding material, the resin has a Hansen solubility parameter HSP of 20.0 or more and 32.0 or less in total, a hydrogen bonding term δH of 4.0 or more and 15.0 or less in total, and a polarity term δP of 8.5 or more and 17.0 or less in total, and when a molded body obtained by using the molding material is fractured, the resin present on the cellulose fibers accounts for 30% or more of an area of 1 mm square of the fracture surface of the molded body.

The present application is based on, and claims priority from JP Application Serial Number 2022-153439, filed Sep. 27, 2022, the disclosure of which is hereby incorporated by reference herein in its entirety.

### BACKGROUND

### 1. Technical Field

The present disclosure relates to a molding material.

### 2. Related Art

In the related art, a molding material including cellulose fibers, a resin, and the like has been known. For example, JP-A-2000-6142 discloses a composite material including fibers derived from paper and a biodegradable resin.

However, the composite material described in JP-A-2000-6142 had the following problem: it was difficult to improve the appearance of a molded article. Specifically, compatibility of the resin with the cellulose fibers has possibly decreased, and the cellulose fibers have sometimes peeled off a surface of a molded article. In addition, the cellulose fibers have easily peeled off when the molded article is subjected to polishing treatment for deburring. Therefore, smoothness of the surface has decreased, and the appearance of the molded article has been possibly impaired. That is, a molding material improving the appearance of a molded article has been desired.

### SUMMARY

The present disclosure is a molding material, including a resin and cellulose fibers, in which the content of the cellulose fibers is 50% by mass or more based on the total mass of the molding material, the resin has a Hansen solubility parameter HSP of 20.0 or more and 32.0 or less in total, a hydrogen bonding term δH of 4.0 or more and 15.0 or less in total, and a polarity term δP of 8.5 or more and 17.0 or less in total, and when a molded body obtained by using the molding material is fractured, the resin present on the cellulose fibers accounts for 30% or more of an area of 1 mm square of the fracture surface of the molded body.

### BRIEF DESCRIPTION OF THE DRAWINGS

FIG. 1 is a table showing compositions, evaluation results, and the like of molding materials according to Examples.

FIG. 2 is a table showing compositions, evaluation results, and the like of molding materials according to Comparative Examples.

FIG. 3 is a SEM observation image of a fracture surface of a test piece of Example.

FIG. 4 is a SEM observation image of a fracture surface of a test piece of Comparative Example.

### DESCRIPTION OF EMBODIMENTS

### 1. Molding Material

A molding material according to the present embodiment includes a resin and cellulose fibers. A molded article produced from the molding material is suitable for various containers, sheets, and casings of office equipment such as a printer, consumer electronics, and the like as a substitute for polystyrene and the like. Hereinbelow, a variety of raw materials included in the molding material will be described.

### 1.1. Resin

The resin has thermoplastic properties and functions as a binding material which is melted to bind cellulose fibers together when a molded articles is produced from the molding material. The binding material contributes to physical properties of a molded article together with the cellulose fibers. Multiple kinds of the resin may be used in combination.

Among resins, a resin having a relatively high polarity increases wettability of the resin against the cellulose fibers. Therefore, compatibility of the resin with the cellulose fibers improves. Hansen solubility parameters described below serve as an index for polarity of a resin. When multiple resins are used in combination, by using resins with polarities relatively closer to each other, miscibility between the resins can be enhanced, and moldability in producing a molded article can be improved.

The resin has the Hansen solubility parameter HSP of 20.0 or more and 32.0 or less in total, the hydrogen bonding term δH of 4.0 or more and 15.0 or less in total, and the polarity term δP of 8.5 or more and 17.0 or less in total. As for characteristic values of each of the Hansen solubility parameter HSP, the hydrogen bonding term δH, and the polarity term δP, known numerical values described in solubility parameter application example collection provided by JOHOKIKO CO., LTD. and articles may be referred to. Examples of the resin include a linear alkyl-based polyester and a highly polar polyester.

When one kind of the resin is used singly, the Hansen solubility parameter HSP in total, the hydrogen bonding term δH in total, and the polarity term δP in total herein refer to the respective characteristic values of the single resin. When two or more kinds of the resin are used in combination, the respective characteristic values referred to are totaled values of all of the resins. Each characteristic value as a total of all resins is calculated from the respective characteristic values of individual resins as a weighted average based on the respective contents.

Furthermore, it is preferable that the resin have the Hansen solubility parameter HSP of 20.0 or more and 22.0 or less in total, the hydrogen bonding term δH of 4.0 or more and 6.5 or less in total, and the polarity term δP of 9.0 or more and 15.0 or less in total. The compatibility of the resin with the cellulose fibers can be further enhanced thereby.

Another resin with one or more of the characteristic values thereof outside the above-described ranges may be used together as long as the totaled characteristic values of resins fall within the above-described ranges. Examples of other resins include a polyethylene terephthalate, an acrylonitrile-butadiene-styrene copolymer resin, a polyoxymethylene, a polyvinyl alcohol, a polyethylene, a polypropylene, and a polystyrene. Commercially available products may be used as the resin described above and as the other resins.

The linear alkyl-based polyester includes, as raw material monomers: an alkyl dicarboxylic acid with an alkylene group having 4 or more and 8 or less carbon atoms; and an alkylene diol with an alkylene group having 2 or more and 8 or less carbon atoms. The linear alkyl-based polyester is formed through copolymerization of the two kinds of raw material monomers. The linear alkyl-based polyester is formed by copolymerizing the two kinds of raw material monomers in a known synthesis method.

Examples of the alkyl dicarboxylic acid include linear saturated aliphatic dicarboxylic acids such as succinic acid, glutaric acid, adipic acid, pimelic acid, suberic acid, azelaic acid, and sebacic acid. One or more kinds thereof are used for synthesis of the linear alkyl-based polyester.

Examples of the alkylene diol include divalent alcohols such as 1,2-ethanediol, 1,3-propanediol, 1,4-butanediol, 1,5-pentanediol, 1,6-hexanediol, 1,7-heptanediol, and 1,8-octanediol. One or more kinds thereof are used for synthesis of the linear alkyl-based polyester. The above-described two kinds of raw material monomers are relatively easily available and applicable for industrial application or commercial application.

Examples of the linear alkyl-based polyester include a polyethylene succinate, a polybutylene succinate, a polybutylene succinate adipate, and a polyethylene diadipate. Since these linear alkyl-based polyesters are biodegradable, the environment burden of molded articles can be reduced.

The highly polar polyester has a molecular structure with a relatively high polarity, in which a repeating structure derived from a raw material monomer has one or more oxygen atoms per two carbon atoms. Specifically, the highly polar polyester includes, as a raw material monomer, lactic acid, hydroxybutyric acid, malic acid, citric acid, malonic acid, succinic acid, serine, threonine, acrylic acid, methyl acrylate, and vinyl acetate.

Examples of the highly polar polyester include polyhydroxy alkanoates such as polylactic acid and polyhydroxybutyrate, and 3-hydroxy(butyrate-co-hexanoate). Those having biodegradability are preferable as the highly polar polyester from the viewpoint of reducing the environment burden.

When multiple kinds of the resin are used in combination, the resin preferably includes one or more resins having the Hansen solubility parameter HSP of 20.0 or more and 22.0 or less, the hydrogen bonding term δH of 4.0 or more and 6.5 or less, and the polarity term δP of 9.0 or more and 15.0 or less. The compatibility of the resin with the cellulose fibers can be further enhanced thereby. When multiple kinds of the resin are used in combination, the resin preferably includes one or more of a polybutylene succinate, a polybutylene succinate adipate, a polylactic acid, and a polyhydroxy alkanoate. The compatibility of the resin with the cellulose fibers can be further enhanced thereby. The characteristic values of these resins will be specifically described in Examples.

### 1.2. Cellulose Fibers

The cellulose fibers function as a filler in a molded article and contribute to increase of bulk of the molding material and improvement in physical properties such as strength of the molded article.

Cellulose fibers are a relatively rich natural material derived from plants. Therefore, reduction in the environment burden is facilitated by using the cellulose fibers as compared with the case where synthetic fibers are used. The cellulose fibers are advantageous also from the points of raw material procurement and costs. In addition, theoretical strength of the cellulose fibers is high among various types of fibers, and the cellulose fibers also contribute to improvement in strength of molded articles. In addition to using virgin pulp, wastepaper, used cloth, and the like may also be reused as the cellulose fibers.

The cellulose fibers are mainly formed from cellulose but may include a component other than cellulose. Examples of the component other than cellulose include hemicellulose and lignin. The cellulose fibers may be subjected to treatment such as bleaching.

The fiber length of the cellulose fibers is preferably less than 500 μm and more preferably less than 50 μm from the viewpoint of improving the appearance of a molded article surface. The fiber length of the cellulose fibers is obtained by a method in accordance with ISO 16065-2:2007.

The content of the cellulose fibers is set to be 50% by mass or more based on the total mass of the molding material. The function of the cellulose fibers as a filler in a molded article can be remarkably exhibited thereby. The content of the cellulose fibers is preferably set to be 80% by mass or less based on the total mass of the molding material. The content of the resin is ensured, and the function of the resin can be sufficiently exhibited in a molded article thereby.

### 1.3. Additive

The molding material may include additives such as a flame retardant, a colorant, an insect repellent, a fungicide, an antioxidant, an ultraviolet absorber, an aggregation inhibitor, and a mold release agent.

### 2. Molding Material Production Method

A molding material production method will be described. A known method can be used for producing the molding material. Specifically, the method described below can be used, for example. The molding material production method is not limited to the method described below.

Firstly, the above-described raw materials are kneaded and made into a strand shape with a monoaxial kneader or a biaxial kneader, followed by pelletizing processing to form a pellet-shaped molding material.

The following method may be used as the molding material production method. Firstly, wastepaper or pulp material is coarsely crushed with a shredder device to obtain cellulose fibers. Then, the cellulose fibers and a resin are weighed and kneaded. Thereafter, the kneaded raw materials are deposited in the air to form a sheet-shaped deposit. The deposit includes a large amount of air and has a small density, and therefore is compressed by a calender device to eliminate air and increase the density, followed by heating in a non-contact manner using a heating furnace and subsequent heat-pressing with a heat-pressing device.

Heating in the heating furnace and the heat-pressing device is conducted at a temperature about 20° C. higher than the melting temperature of the resin. A sheet in which each raw material is dispersed with suppressed unevenness is formed thereby.

Thereafter, the sheet is cut into a desired shape with a shredder device to obtain a pellet-shaped molding material. The desired shape of the molding material is not particularly limited but is an approximately cubic shape from a 2-mm cube to a 5-mm cube.

The molding material is produced by the above production methods. A known molding method such as injection molding and pressing can be used to produce a molded body, which is a molded article, from the molding material. When the molded body obtained by using the molding material is fractured, the fracture surface of the molded body is made to have the state described below.

That is, the resin present on the surfaces of the cellulose fibers accounts for 30% or more of an area of 1 mm square of the fracture surface of the molded body. The above-described state is confirmed by observation with a scanning electron microscope (SEM) or by mapping analysis on a certain molecular structure through a Raman spectroscopy, for example. The certain molecular structure is a molecular structure which is not included in the cellulose fibers and is peculiar to the resin, such as a carbonyl group.

The amount of the resin present on the cellulose fibers can be obtained by analyzing an observation image from a scanning electron microscope, a mapping image from Raman spectroscopy, and the like using image analysis software and the like.

The state where the resin present on the surfaces of the cellulose fibers accounts for 30% or more is also a state where the cellulose fibers and the resin are not separated at the boundary therebetween, and the cellulose fibers and the resin undergo brittle fracture or ductile fracture. That is, it can be said that compatibility of the resin with the cellulose fibers is high, and the resin remains on the surfaces of the cellulose fibers at the fracture surface in the above-described state.

According to the present embodiment, the following effect is provided. The appearance of a molded article can be improved. Specifically, compatibility of the resin with the cellulose fibers, in other words, wettability of the resin against the cellulose fibers is enhanced since the Hansen solubility parameter HSP, the hydrogen bonding term δH, and the polarity term δP fall within the above-described ranges. Therefore, when a molded article is produced from the molding material, the cellulose fibers is made difficult to peel off a surface of the molded article, for example. Furthermore, as the cellulose fibers are made difficult to peel off a surface of the molded article, generation of dust from the molded article can be reduced. Accordingly, a molding material improving the appearance of a molded article can be provided.

### 3. Examples and Comparative Examples

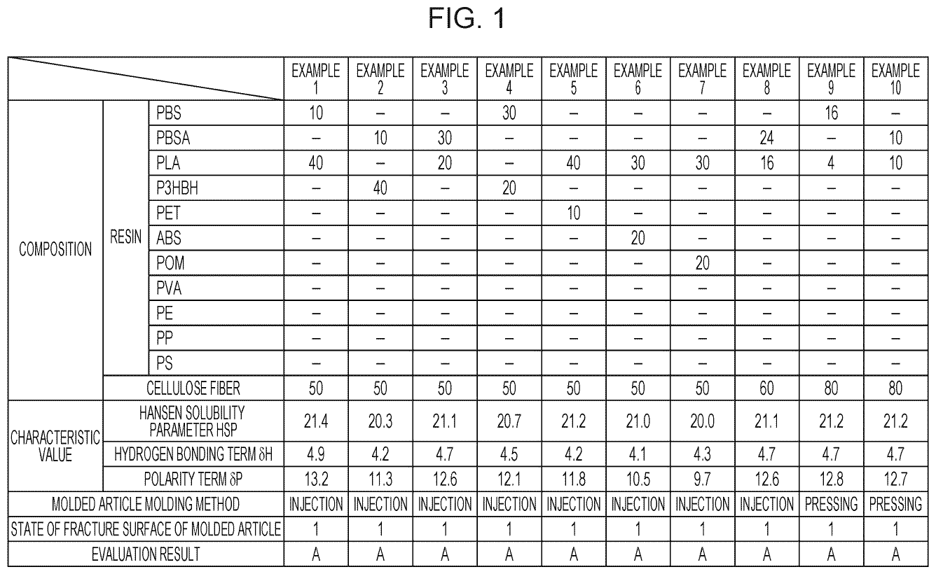

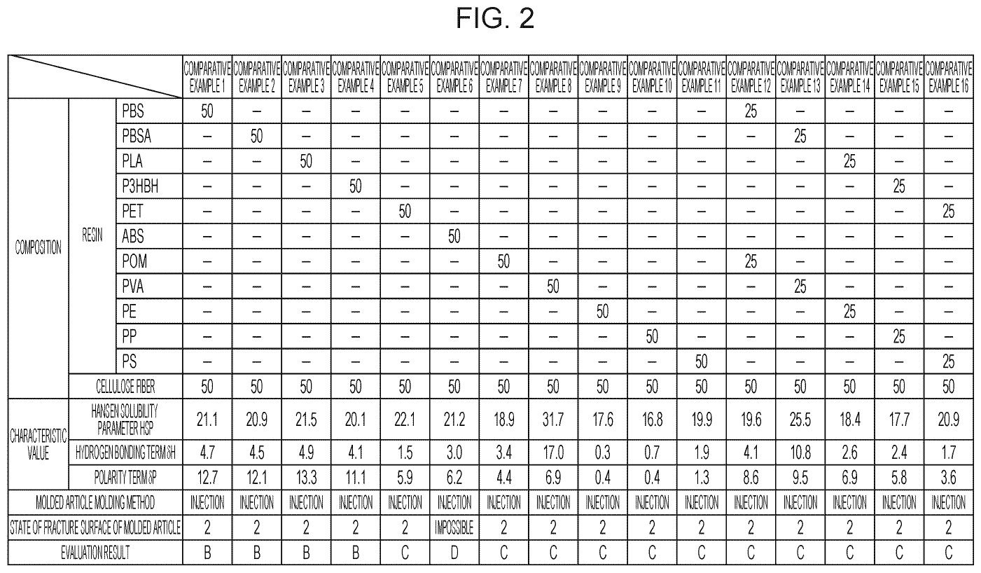

Hereinafter, the effect of the present disclosure will be specifically described by showing Examples and Comparative Examples. Compositions of raw materials, evaluation results of molded articles, and the like pertaining to the respective molding materials of Example 1 to Example 10 are shown in FIG. 1. Compositions of raw materials, evaluation results of molded articles, and the like pertaining to the respective molding materials of Comparative Example 1 to Comparative Example 16 are shown in FIG. 2.

In the composition rows in FIG. 1 and FIG. 2, units for the numerical values are mass %, and the cell with no numerical value and with the symbol - indicates absence. Abbreviations are used to represent the names of the raw materials. The respective abbreviations are described later. In the following description, Example 1 to Example 10 are also collectively referred to as Examples, and Comparative Example 1 to Comparative Example 16 are also collectively referred to as Comparative Examples. Note that, the present disclosure is not limited to the following Examples.

Molding materials of Examples and Comparative Examples were produced according to the compositions in FIG. 1 and FIG. 2. Specifically, the resin and the cellulose fibers were weighed, put into a biaxial kneader KZW15TW-45MG from TECHNOVEL CORPORATION, and kneaded. The highest heating temperature of 180° C. and an extrusion discharging amount of 1 kg/hr were employed as kneading conditions. Then, after processing into a strand shape, a molding material having a pellet shape was produced by a pelletizer.

In the characteristic value rows in FIG. 1 and FIG. 2, with respect to a standard using one kind of resin, the characteristic values of the single resin were recorded, and with respect to a standard using multiple kinds of resins, characteristic values arithmetically totaled were recorded. The abbreviations and specifics of the raw materials used in FIG. 1 and FIG. 2 are as follows.

### Resins

PBS: polybutylene succinate, product name: BioPBS FZ71PB, Mitsubishi Chemical Corporation

PBSA: polybutylene succinate adipate, product name: BioPBS FD92PB, Mitsubishi Chemical Corporation

PLA: polylactic acid, product name: TERRAMAC (registered trademark) TE-2000, UNITIKA Ltd.

P3HBH: 3-hydroxy(butylate-co-hexanoate), product name: Green Planet (registered trademark), KANEKA CORPORATION Other resins

PET: polyethylene terephthalate, product name: NEH-2070, UNITIKA Ltd.

ABS: acrylonitrile-butadiene-styrene copolymer resin, product name: TOYOLAC (registered trademark) 500, Toray Plastics, Inc.

POM: polyoxymethylene, product name: DURACON (registered trademark) M90-44, POLYPLASTICS CO., LTD.

PVA: polyvinyl alcohol, product name: Mowiflex (registered trademark) C17, Kuraray Co., Ltd.

PE: polyethylene, product name: NEO-ZEX (registered trademark) 20201J, Prime Polymer Co., Ltd.

PP: polypropylene, product name: AZ564, SUMITOMO CHEMICAL Co., Ltd.

PS: polystyrene, product name: Styron (registered trademark) 438, The Dow Chemical Company

Cellulose fibers, product name: Guaiba BEKP, CMPC S.A.

Test pieces for evaluation were prepared through injection molding or pressing by using the molding materials of Examples and Comparative Examples. Specifically, the temperature at which the molding materials were heated was set to 200° C. in the both cases of injection molding and pressing. THX40-5V from NISSEI PLASTIC INDUSTRIAL CO., LTD. was used as an injection molding device, and hydraulic press PHKS-40ABS from TOWA SEIKI CO., LTD was used as a pressing device. The shape of the test pieces was a rectangular plate shape having a length of 80 mm±2 mm, a width of 4.0 mm±0.2 mm, and a thickness of 10.0 mm±0.2 mm. Note that the molding material of Comparative Example 6 could not be molded into a test piece.

The test piece of each of Examples and Comparative Examples was fractured with plastic hummer 70X1 from VESSEL CO., INC., and the fracture surface was observed. Specifically, appearance observation with scanning electron microscope S-4800 from Hitachi High-Tech Corporation and mapping analysis, with an imaging microscopic Raman device from Thermo Fisher Scientific Inc., on an area of 1 mm square of the fracture surface were conducted.

In the row of “state of fracture surface of molded article”, 1 was recorded when the resin present on the cellulose fibers accounted for 30% or more of the area of 1 mm square of the fracture surface of each test piece, and 2 was recorded when the resin present on the cellulose fibers accounted for less than 30% of the area of 1 mm square of the fracture surface of each test piece.

Example 1 is a standard of a molded article produced by injection molding, in which the content of PBS was 10% by mass, the content of PLA was 40% by mass, and the content of cellulose fibers was 50% by mass. The state of the fracture surface of the test piece is 1.

Example 2 is a standard in which PBS was replaced by PBSA and PLA was replaced by P3HBH compared with Example 1. The state of the fracture surface of the test piece is 1.

Example 3 is a standard of a molded article produced by injection molding, in which the content of PBSA was 30% by mass, the content of PLA was 20% by mass, and the content of cellulose fibers was 50% by mass. The state of the fracture surface of the test piece is 1.

Example 4 is a standard in which PBSA was replaced by PBS and PLA was replaced by P3HBH compared with Example 3. The state of the fracture surface of the test piece is 1.

Example 5 is a standard of a molded article produced by injection molding, in which the content of PLA was 40% by mass, the content of PET was 10% by mass, and the content of cellulose fibers was 50% by mass. The state of the fracture surface of the test piece is 1.

Example 6 is a standard of a molded article produced by injection molding, in which the content of PLA was 30% by mass, the content of ABS was 20% by mass, and the content of cellulose fibers was 50% by mass. The state of the fracture surface of the test piece is 1.

Example 7 is a standard in which ABS was replaced by POM compared with Example 6. The state of the fracture surface of the test piece is 1.

Example 8 is a standard of a molded article produced by injection molding, in which the content of PBSA was 24% by mass, the content of PLA was 16% by mass, and the content of cellulose fibers was 60% by mass. The state of the fracture surface of the test piece is 1.

Example 9 is a standard of a molded article produced by pressing, in which the content of PBS was 16% by mass, the content of PLA was 4% by mass, and the content of cellulose fibers was 80% by mass. The state of the fracture surface of the test piece is 1.

Example 10 is a standard of a molded article produced by pressing, in which the content of PBSA was 10% by mass, the content of PLA was 10% by mass, and the content of cellulose fibers was 80% by mass. The state of the fracture surface of the test piece is 1.

Comparative Example 1 is a standard of a molded article produced by injection molding, in which the content of PBS was 50% by mass, and the content of cellulose fibers was 50% by mass. The state of the fracture surface of the test piece is 2.

Comparative Example 2 is a standard in which PBS was replaced by PBSA compared with Comparative Example 1. The state of the fracture surface of the test piece is 2.

Comparative Example 3 is a standard in which PBS was replaced by PLA compared with Comparative Example 1. The state of the fracture surface of the test piece is 2.

Comparative Example 4 is a standard in which PBS was replaced by P3HBH compared with Comparative Example 1. The state of the fracture surface of the test piece is 2.

Comparative Example 5 is a standard in which PBS was replaced by PET compared with Comparative Example 1. The state of the fracture surface of the test piece is 2.

Comparative Example 6 is a standard in which PBS was replaced by ABS compared with Comparative Example 1. Processing into a test piece was impossible, and fracture surface observation was not conducted.

Comparative Example 7 is a standard in which PBS was replaced by POM compared with Comparative Example 1. The state of the fracture surface of the test piece is 2.

Comparative Example 8 is a standard in which PBS was replaced by PVA compared with Comparative Example 1. The state of the fracture surface of the test piece is 2.

Comparative Example 9 is a standard in which PBS was replaced by PE compared with Comparative Example 1. The state of the fracture surface of the test piece is 2.

Comparative Example 10 is a standard in which PBS was replaced by PP compared with Comparative Example 1. The state of the fracture surface of the test piece is 2.

Comparative Example 11 is a standard in which PBS was replaced by PS compared with Comparative Example 1. The state of the fracture surface of the test piece is 2.

Comparative Example 12 is a standard of a molded article produced by injection molding, in which the content of PBS was 25% by mass, the content of POM was 25% by mass, and the content of cellulose fibers was 50% by mass. In Comparative Example 12, one or more of the three characteristic values including the Hansen solubility parameter HSP fall outside the ranges described above. The state of the fracture surface of the test piece is 2.

Comparative Example 13 is a standard in which PBS was replaced by PBSA, and POM was replaced by PVA compared with Comparative Example 12. The state of the fracture surface of the test piece is 2 in Comparative Example 13.

Comparative Example 14 is a standard in which PBS was replaced by PLA, and POM was replaced by PE compared with Comparative Example 12. In Comparative Example 14, all of the three characteristic values including the Hansen solubility parameter HSP fall outside the ranges described above. The state of the fracture surface of the test piece is 2.

Comparative Example 15 is a standard in which PBS was replaced by P3HBH, and POM was replaced by PP compared with Comparative Example 12. In Comparative Example 15, all of the three characteristic values including the Hansen solubility parameter HSP fall outside the ranges described above. The state of the fracture surface of the test piece is 2.

Comparative Example 16 is a standard in which PBS was replaced by PET, and POM was replaced by PS compared with Comparative Example 12. In Comparative Example 16, one or more of the three characteristic values including the Hansen solubility parameter HSP fall outside the ranges described above. The state of the fracture surface of the test piece is 2.

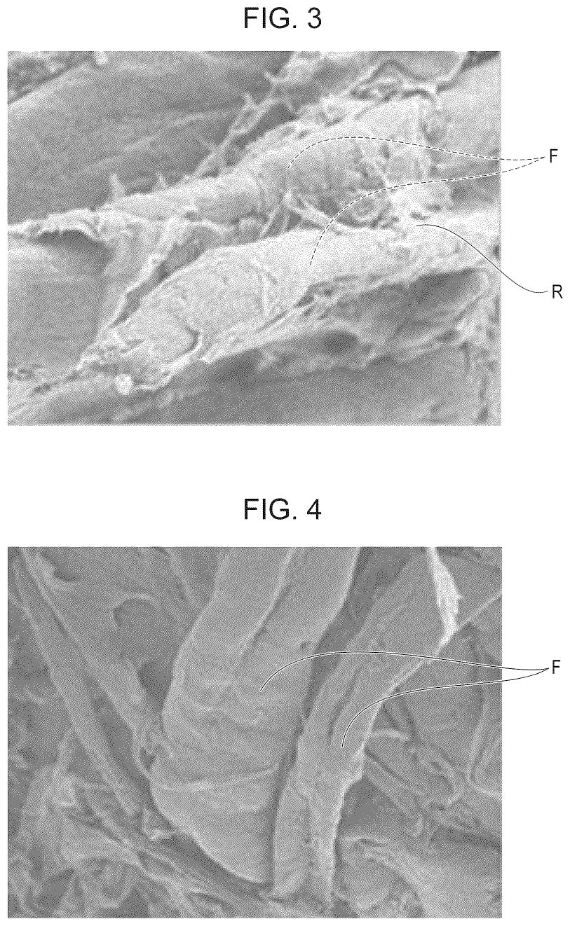

The states of the fracture surfaces of the test pieces in Examples and Comparative Examples will be described. FIG. 3 is a SEM observation image of the fracture surface of the test piece of Example 3, and FIG. 4 is a SEM observation image of the fracture surface of the test piece of Comparative Example 2. Incidentally, although illustration by means of figures is omitted, states of the fracture surfaces in Examples other than Example 3 were similar to that in Example 3, and states of the fracture surfaces in Comparative Example 6 and Comparative Examples other than Comparative Example 2 were similar to that in Comparative Example 2.

As illustrated in FIG. 3, the resin R remains on the surfaces of the cellulose fibers F on the fracture surface of the test piece in Example 3. The resin R on the cellulose fibers F shows, in places, traces extending in a string shape. This suggests that the fracture of the test piece was ductile fracture. This is because since compatibility of the resin R with the cellulose fibers F is high, part of the resin R remained while being attached to the surfaces of the cellulose fibers F when the test piece was fractured.

On the other hand, as illustrated in FIG. 4, the resin R remaining on the surfaces of the cellulose fibers F hardly appears on the fracture surface of the test piece in Comparative Example 2. This suggests that the fracture of the test piece was boundary separation. This is because since compatibility of the resin R with the cellulose fibers F is low, the resin R and the cellulose fibers F were separated at the boundary therebetween when the test piece was fractured, and the resin R scarcely remained on the cellulose fibers F.

Whether cellulose fibers peeled off a surface of a molded article or not was employed as an evaluation index of the appearance of the molded article. Specifically, whether cellulose fibers peeled off a surface of a molded article or not was investigated with respect to an untreated molded article surface and to a molded article surface having been subjected to polishing treatment with sandpaper (count: #40). Obtained results were evaluated according to the following judging criteria.

### Judging Criteria

A: Peeling was not observed in both cases with and without polishing treatment
B: Peeling was not observed in the case without polishing treatment but observed in the case with polishing treatment
C: Peeling was observed in both cases with and without polishing treatment
D: Molding processing was impossible

As shown in FIG. 1 and FIG. 2, all standards in Examples were rated as A and demonstrated improvement in the appearance of the molded articles. On the other hand, all standards in Comparative Examples were rated as B or lower, revealing that the appearance of the molded articles is hardly improved.

What is claimed is:

1. A molding material, comprising a resin and cellulose fibers, wherein
a content of the cellulose fibers is 50% by mass or more based on a total mass of the molding material,
the resin has a Hansen solubility parameter HSP of 20.0 or more and 32.0 or less in total, a hydrogen bonding term δH of 4.0 or more and 15.0 or less in total, and a polarity term δP of 8.5 or more and 17.0 or less in total, and
when a molded body obtained by using the molding material is fractured, the resin present on the cellulose fibers accounts for 30% or more of an area of 1 mm square of a fracture surface of the molded body.

2. The molding material according to claim 1, wherein
the resin has the Hansen solubility parameter HSP of 20.0 or more and 22.0 or less in total, the hydrogen bonding term δH of 4.0 or more and 6.5 or less in total, and the polarity term δP of 9.0 or more and 15.0 or less in total.

3. The molding material according to claim 1, wherein
the resin includes one or more resins having the Hansen solubility parameter HSP of 20.0 or more and 22.0 or less, the hydrogen bonding term δH of 4.0 or more and 6.5 or less, and the polarity term δP of 9.0 or more and 15.0 or less.

4. The molding material according to claim 3, wherein
the resin includes one or more of a polybutylene succinate, a polybutylene succinate adipate, a polylactic acid, and a polyhydroxy alkanoate.
